(19) United States
(12) Patent Application Publication
(10) Pub. No.: US 2012/0327051 A1
(43) Pub. Date: Dec. 27, 2012

(54) VISUAL DISPLAYS FOR AN AIRCRAFT FLIGHT DECK

(75) Inventor: John Alun Davies, Gloucestershire (GB)

(73) Assignee: GENERAL ELECTRIC COMPANY, Schenectady, NY (US)

(21) Appl. No.: 13/224,464

(22) Filed: Sep. 2, 2011

(30) Foreign Application Priority Data
Jun. 22, 2011 (GB) 11105731

(51) Int. Cl. G06F 3/038

(52) U.S. Cl. 345/207

(57) ABSTRACT

A cockpit for an aircraft includes a windscreen through which light may pass, at least one seat spaced from and facing the windscreen, a flight deck having at least a portion disposed below the windscreen and having at least one head down display having an adjustable brightness that may be set by a brightness signal, a camera having a field of view including at least a portion of the at least one seat and outputting an image signal indicative of luminance information within the field of view, and a processor operably coupled to the camera and the head down display and configured to receive the image signal, determine a luminance of at least a portion of the field of view, determine a brightness for the head down display based on the determined luminance, and outputting to the head down display a brightness signal corresponding to the determined brightness.

### CROSS-REFERENCE TO RELATED APPLICATIONS

This application claims priority under 35 U.S.C. §119 to British Patent Application No. 11105731, filed Jun. 22, 2011, the disclosure of which is incorporated herein by reference.

### BACKGROUND OF THE INVENTION

Contemporary aircraft cockpits include a flight deck having one or more head down displays (HDD), which display to the pilot and flight crew a wide range of aircraft, flight, navigation, and other information used in the operation and control of the aircraft. The displays may be illuminated to help pilots view and locate the relevant information. The brightness is varied in response to the ambient lighting conditions to provide the pilots better visibility of the displayed information. For example, during normal daylight conditions it may be necessary to illuminate the display to a high brightness level so that the pilot may easily view the display. Under night conditions that same amount of brightness may render the display too bright for use and could interfere with a pilot's ability to readily view and perceive other less luminous objects. Additionally, sunlight shining directly on a HDD or shining directly into the pilot's eyes makes reading the display very difficult, unless the brightness of the display is adjusted to compensate.

### BRIEF DESCRIPTION OF THE INVENTION

In one embodiment, a cockpit for an aircraft includes a windscreen having at least one transparent pane through which light may pass, at least one seat spaced from and facing the windscreen, a flight deck having at least a portion disposed below the windscreen and having at least one head down display having an adjustable brightness that may be set by a brightness signal, a camera having a field of view including at least a portion of the at least one seat and outputting an image signal indicative of luminance information within the field of view, and a processor operably coupled to the camera and the head down display. The processor is configured to receive the image signal, determine a luminance of at least a portion of the field of view, determine a brightness for the head down display based on the determined luminance, and outputting to the head down display a brightness signal corresponding to the determined brightness.

In another embodiment, a head down display assembly for a flight deck of an aircraft, includes a housing, a head down display mounted within the housing and having a viewing angle, a camera carried by the housing and having a field of view encompassing at least a portion of the viewing angle and outputting an image signal indicative of luminance information within the field of view, an image processor operably coupled to the camera to receive the image signal and output a luminance signal corresponding to the image signal, and a graphics processor operably coupled to the image processor and receiving the luminance signal and correspondingly adjusting a brightness of the head down display.

In yet another embodiment, a method of adjusting a brightness level of at least one head down display in a cockpit of an aircraft, includes taking an image of at least a portion of the cockpit within a viewing angle of the head down display, determining a luminance of at least a portion of the image, and setting the brightness level of the head down display according to the determined luminance.

### BRIEF DESCRIPTION OF THE DRAWINGS

In the drawings:

FIG. 1 is a perspective view of a portion of an aircraft cockpit with a flight deck known in the prior art.

FIG. 2 is a perspective view of a portion of an aircraft cockpit with a flight deck having multiple head down display assemblies according to the invention.

FIG. 3 is a top view of a portion of the aircraft cockpit of FIG. 2.

FIG. 4 is a schematic view of a head down display assembly which may be used in the flight deck of FIGS. 2 and 3.

### DESCRIPTION OF EMBODIMENTS OF THE INVENTION

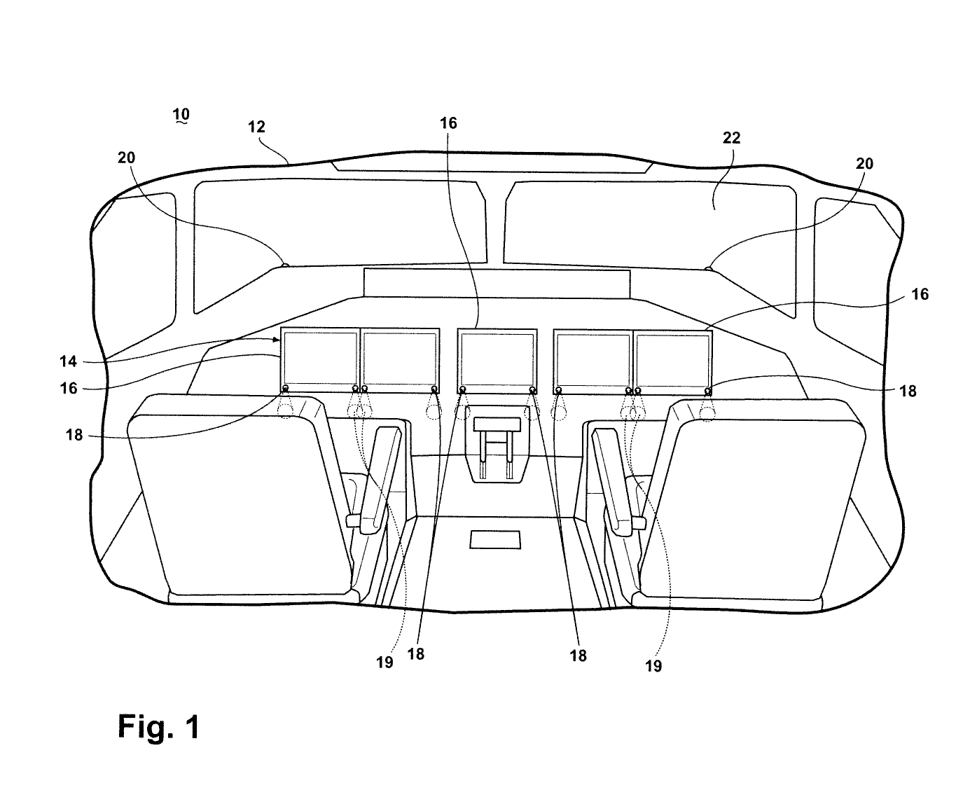

FIG. 1 illustrates a portion of a prior art aircraft 10 having a cockpit 12 with a flight deck 14 having multiple head down displays 16. The head down displays 16 are typically illuminated and capable of having various brightness levels depending on ambient lighting in the cockpit 12. Ambient light sensors 18 are typically located on the displays 16 and typically detect light that falls directly on the ambient light sensor 18. The ambient light sensors 18 measure luminance that falls directly on the sensor 18, which defines an effective field of view 19 for the sensor 18, which is relatively limited compared to the cockpit 12. The field of view 19 is illustrated as a cone, which identifies the area in which light may fall on the sensor. Depending on the shape and angle of the sensor 18, the cone may be bigger or smaller than illustrated and may be angled differently than as illustrated. Depending on its position relatively to the source of the ambient light, such as the sun, the sensor 18 may or may not give a true measure of the light falling on the display 16. For example, the ambient light sensor 18 may lie in the shade while the majority of the display 16 may be directly illuminated by ambient light.

The light sensors 18 are typically mounted within the housing surrounding the display. Multiple ambient light sensors 18 may be placed on the housing about the display to detect light falling on different portions of the display 16. However, there are practical limitations to this approach, such as available space and cost.

The sensors 18 are known to not give an accurate light determination where a portion of the display 16 is in shadow, while another portion thereof is in bright sunlight. This may potentially result in the display 16 being inadvertently dimmed and made unreadable, and as the same approach is used in all the displays it could result in all the displays 16 dimming simultaneously.

Due to the general location of these ambient lighting sensors 18 within the flight deck 14, it may be exceedingly difficult for the sensors 18 to accurately determine the amount of illumination in the cockpit 12 and how much illumination is entering the pilot's eyes. A typical problem is when the aircraft 10 flies into the sun with no light falling on the display 16 resulting in the displays 16 dimming down. At the same time, the pilots are looking directly into the sun and consequently are unable to see the displays 16. Thus, the sensors 18 only sense the light falling on them, which is not guaranteed to be the same light that is falling on the pilot's eyes. To aid in this issue, forward looking remote light sensors 20 are often include in such aircrafts 10 to detect light coming through the windscreen 22, which will correlate to light that will be directed into the pilot's eyes. The brightness of the display 16 may be controlled by the light detected by both types of sensors 18, 20. The multitude of sensors 18, 20 needed to make a semi-accurate determination of the illumination level within the cockpit 12 are often costly and sometimes are unable to determine accurate light levels within the cockpit 12 leading to displays 16 with potentially problematic brightness levels.

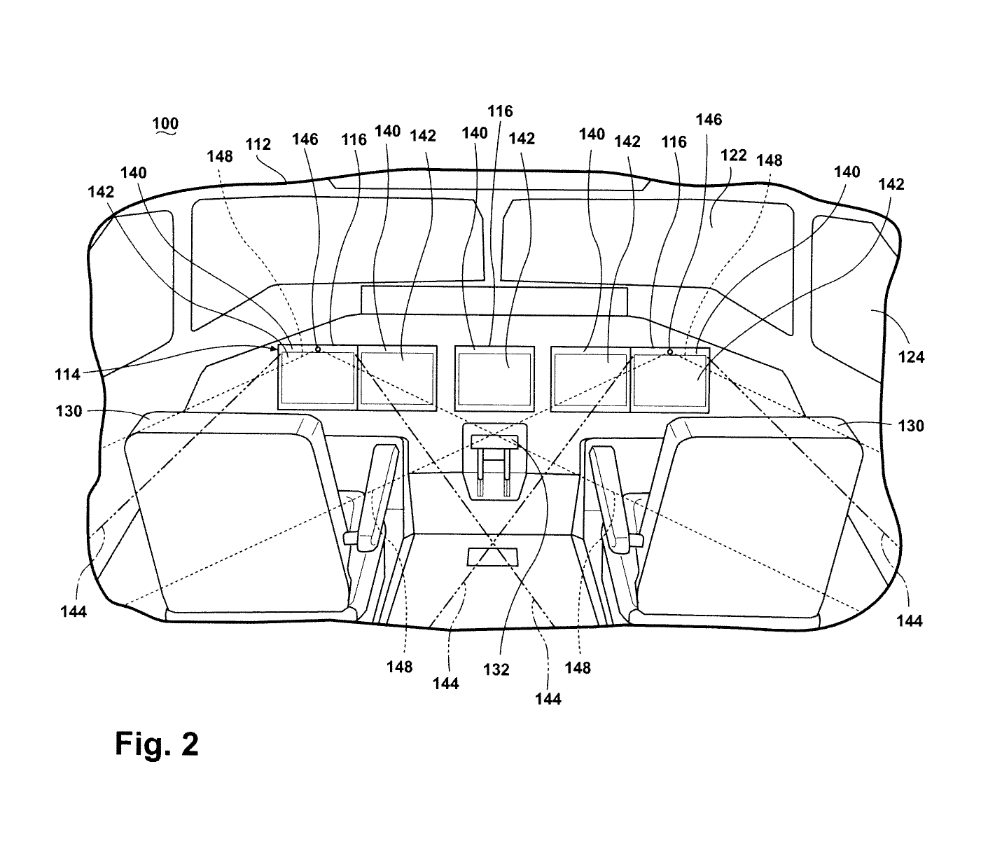

FIG. 2 illustrates a portion of an aircraft 100 having a cockpit 112 with a flight deck 114 having multiple head down display (HDD) assemblies 116. While illustrated in a commercial airliner, the inventive HDD assemblies 116 may be used in any type of aircraft, for example, without limitation, fixed-wing, rotating-wing, rocket, commercial aircraft, personal aircraft, and military aircraft.

A windscreen 122 may be positioned in a front area of the cockpit 112 and may have at least one transparent pane through which light may pass. The windscreen 122 has been illustrated as including two transparent panes positioned in a front area of the cockpit to allow the flight crew to see outside the cockpit 112 in front of the aircraft 100. One or more windows 124 may also be included on the sides of the cockpit 112. The windows 124 may also include transparent panes through which light may pass and through which the flight crew may see additional areas outside the cockpit 112.

One or more seats 130 are positioned in the cockpit 112 and are spaced from and face the windscreen 122. Two seats 130 have been illustrated in a side-by-side arrangement. It is contemplated that fewer or more seats may be included in the cockpit 112 and that additional seats may face forward towards the windscreen 122 or may face sideways towards the windows 124.

The flight deck 114 may include various instruments and control mechanisms 132 as well as a plurality of HDD assemblies 116 all of which enable the flight crew to fly the aircraft 100. The flight deck 114 may be positioned around the seats 130 and a portion of the flight deck 114 may be disposed below the windscreen 122 as illustrated. Further, the HDD assemblies 116 may be located below the windscreen 122. It is also contemplated that portions of the flight deck 114 including HDD assemblies 116 may be located above the windscreen 122. It will be understood that the HDD assemblies 116 may be configured in any number and layout and that their configuration is not limited to the illustrated example.

The HDD assemblies 116 may each include a housing 140 and a head down display (HDD) 142 mounted within the housing 140. The HDD 142 may be any suitable type of display having an adjustable brightness that may be set by a brightness signal including by way of non-limiting examples an LCD display or an LED display. Each HDD 142 may have a viewing angle 144, which has been schematically illustrated for several of the HDDs 142 and is a maximum angle at which the HDD 142 may be viewed with acceptable visual performance. If the HDD 142 is viewed from outside the viewing angle 144 the HDD 142 may lose brightness or may have color shifts.

A camera 146 may be mounted to or carried by on one or more of the HDD assemblies 116. By way of non-limiting example, a camera 146 has been illustrated as being incorporated into two of the HDD assemblies 116. The remaining HDD assemblies 116 may be considered non-camera HDD assemblies 116. It is contemplated that the HDD assemblies 116 having the cameras 146 may be located in various locations on the flight deck 114. It is also contemplated that each of the HDD assemblies 116 may have a camera 146. Further, it has been contemplated that a single HDD 116 may have a camera 146.

In the illustrated embodiment, each camera 146 may reside within a separate housing 140 and may be aligned with an opening in the corresponding housing 140. The camera 146 may be any suitable type of camera for outputting an image signal indicative of luminance information within the camera field of view. Exemplary cameras include a CCD camera, a CMOS camera, a digital camera, a video camera, or any other type of device capable of capturing an image.

Each camera 146 may have a field of view 148, which has been schematically illustrated with phantom lines and is the area of coverage of the camera 146. It is contemplated that the camera field of view 148 may include at least a portion of one seat 130 and as illustrated may encompass at least a portion of each of the two seats 130. The camera field of view 148 may encompass at least a portion of the head down display viewing angle 144. The overlapping portions of the camera field of view and the head down display viewing angle 144 has been illustrated as including a portion of each of the two seats 130. It is also illustrated that an entire width of the cockpit 112 may be in the field of view 148 of the cameras 146. It is also contemplated that the entire width of the cockpit 112 may be in the field of view 148 of a single camera 146.

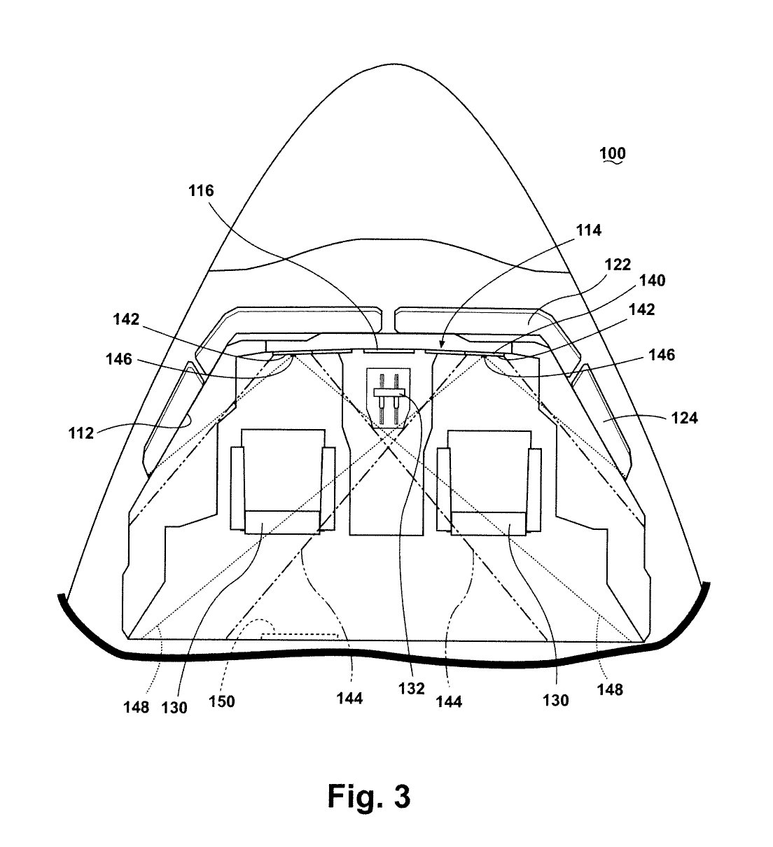

FIG. 3 more clearly illustrates the exemplary head down display viewing angles 144 and the camera field of views 148. FIG. 3 also illustrates that a luminance target 150 (shown in phantom) having a predetermined reflectance may be included in the cockpit 112 within the camera field of view 148. Such a luminance target 150 may simply be a surface or wall with a known reflectance. It is contemplated that the illumination target 150 may be a neutral gray, such as an 18% gray, to provide a flat reflectance spectrum across the visible spectrum. The illumination target 150 could be a card or similar structure on a wall of the cockpit or the cockpit could be painted with such a color. The location of the camera 146 may be fixed relative to the cockpit 112, which simplifies determining which parts of the image relate to which parts of the cockpit 112. Thus, it is possible to process discrete parts of the image to determine different luminances and make better processing decisions. For example, the seats 130 have limited adjustability and the variation in the height of the pilots is limited, such that a predetermined area in which the pilots head would fall within the image would be known. The neutral gray could form the backdrop for the head area.

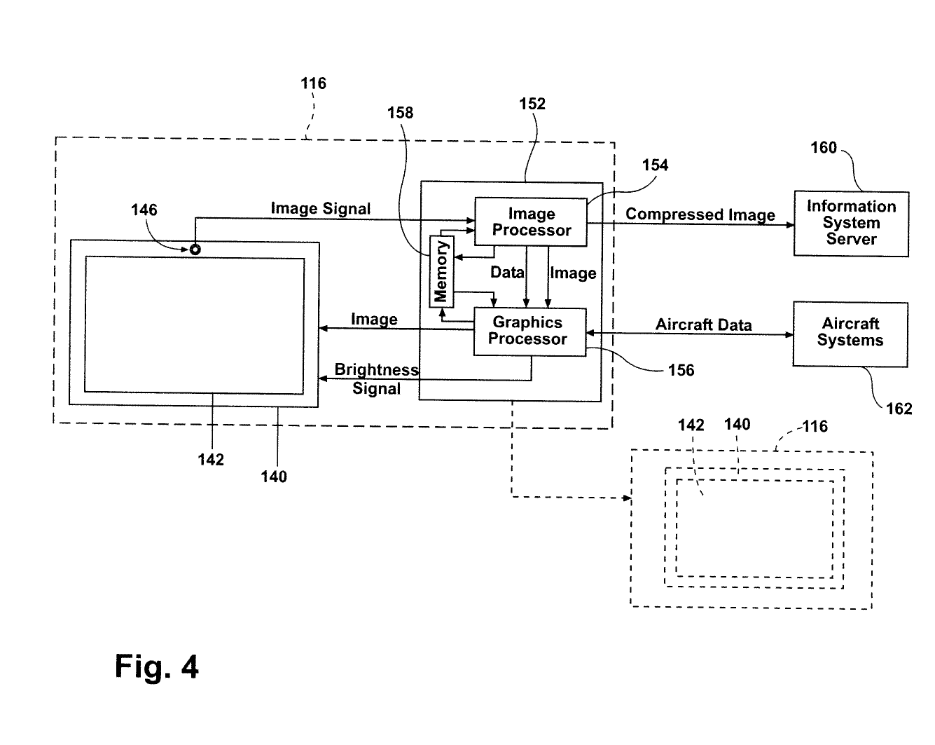

FIG. 4 illustrates that a processor or controller 152 for processing the image from the camera and adjusting the brightness of the display in accordance with the processed image. For convenience, the controller 152 may be included in the HDD assembly 116 having the camera 146. The controller 152 may be operably coupled to the camera 146 and the head down display 142. An image processor 154 and a graphics processor 156 as well as any associated memory 158 may be included in the controller 152. The image processor 154 may be operably coupled to the camera 146 and may receive an image signal from the camera 146. The image processor 154 may be any suitable image processor capable of determining a luminance of at least a portion of the image and outputting a luminance signal corresponding to the determined luminance of the image signal.

The graphics processor 156 may be operably coupled to the image processor 154 and the HDD 142. The graphics processor 156 may be any suitable graphics processor capable of receiving the luminance signal and determining a brightness level for the HDD 142 based on the determined luminance. The graphics processor 156 may be capable of outputting to the HDD 142 a brightness signal corresponding to the determined brightness and thus may correspondingly adjust a brightness of the HDD 142.

The memory 158 may be used for storing control software of the image processor 154 and the graphics processor 156 and any additional software needed by the controller 152. The memory 158 may also be used to store information, such as a database or table, and to store images or video received from the camera 146.

The controller 152 may also be operably coupled with one or more components of the aircraft 100 for communicating with the components. For example, an information system server 160, air craft systems 162, and a non-camera HDD assembly 116 have been illustrated as being coupled with the controller 152. The information systems server 160 may receive compressed images or video from the image processor 154 while the aircraft systems 162 may supply aircraft data to the HDD assembly 116 so that such information may be illustrated on the HDD 142. The aircraft systems may also receive information from the controller 152. In the case where a single camera 146 is used to control multiple HDDs 142 the controller 152 may also be operably coupled to the additional non-camera HDD assembly 116 and (shown in phantom) and may be configured to control the brightness of the HDD 142 thereof. Such non-camera HDD assemblies 116 may have also have a controller (not illustrated), which may be also be used in operating the non-camera HDD assembly 116.

During operation of the aircraft 100 a brightness level of at least one HDD 142 in the cockpit 112 may be adjusted by a brightness signal based on an image or video taken by the camera 146. More specifically, an image may be taken of at least a portion of the cockpit 112 within the viewing angle 144 of the HDD 142. If the camera 146 is a video camera then this may include taking a video. The image or video may be sent to the image processor 154 and a luminance of at least a portion of the image may be determined by the image processor 154, which may use image processing software to determine the luminance in the captured image. Any suitable software may be used to determine the amount of ambient light in a portion of the image. The software may ensure that the image from the camera 146 is stored in a luminance/chrominance color space (e.g. YCrCb or YUV) so that the software may see the luminance component. Then a histogram analysis of the image may be performed where the luminance levels of the images are split in number of ranges and determined the number of pixels with in each luminance range. This may be used to determine general level of luminance of the image. From the histogram analysis a distribution of the luminance may be determined. Once the distribution of the luminance is determined the mean or median luminance and consequently an estimation of the ambient light in the scene may also be determined.

It is contemplated that the image processing may also be performed in smaller areas of the image, in order to look for specific elements in the cameras field of view, such as the window or an area on the back of the cockpit wall. This would allow different components of the overall ambient light in the scene to be calculated. It is contemplated that these areas may be different for each display camera and may vary between different aircraft types.

It is contemplated that the luminance may be determined over the entire image or any portion of the image. The image processor 154 may also determine light being received from directly in front of the aircraft 100 from reflections on the back of the cockpit 112 and the pilot. It is contemplated that determining the luminance may also include determining the luminance of a portion of the image corresponding to the reflectance target 150 in the cockpit 112. The image processor may determine the luminance on the surface based on the known reflectance and thus determine the luminance for that portion. Based on the determined luminance the controller 152 may set the brightness level of the HDD 142. More specifically, the controller 152 output send a brightness signal corresponding to the determined brightness level to the HDD 142.

If multiple images are taken, the luminance may be repeatedly determined. The controller 152 may determine a luminance of each image and may set the brightness level for the HDD 142 with each determined luminance. In the case where a video is taken, then the luminance may be repeatedly determined over time and setting the brightness level may include repeatedly setting the brightness level according to the repeatedly determined luminance. It is contemplated that such repeated determination of the luminance of the images or video may be continuous and in this manner the brightness of the HDD 142 may be continuously adjusted.

In the case of multiple cameras 146, the image processor 154 may be capable of combining the images and the controller 152 may be able to determine a luminance profile for the entire cockpit 112. In this manner, data from multiple cameras may be combined to form scene luminance data which may be shared between all of the HDDs 142. Furthermore, in the case of multiple cameras 146, the controller 152 may use an average or weighted average of the determined luminance for each image. It is also contemplated that each HDD 142 may bias its brightness towards its own luminance determination, but use the other luminance levels to get general scene luminance values.

It is also contemplated that the image or video taken by a single camera may be of a least a portion of the cockpit 112 within the viewing angles 144 of at least two HDDs 142 and that a single camera 146 may be used to provide images or video to a controller 152 to control multiple HDDs 142. In such an instance, determining the luminance may include determining the luminance for a portion of the image within each of the viewing angles 144. The controller 152 may be configured to determine brightness for the non-camera HDD assembly 116 based on the determined luminance in a portion of the image corresponding to its viewing angle 144. The controller 152 may determine an appropriate brightness for the non-camera HDD 142 based on the determined luminance and may output to the non-camera HDD assembly 116 a brightness signal corresponding to the determined brightness. In this manner, the brightness of the non-camera HDD 142 may also be controlled.

The above described inventive embodiments allow better sensing of the ambient light conditions in the cockpit 112, including light being received from directly in front of the aircraft 100. The camera 146 may replace multiple ambient light sensors both those mounted on the display and those mounted remotely to determine light being received from in front of the aircraft. The camera 146 allows for a more sophisticated measure of the luminance in the cockpit 112 to be determined by looking at a much wider field of view of the cockpit 112.

It will be understood that other advantages may also be realized by having a camera in the cockpit 112 wherein the seat 130 is within the camera field of view 148. Such an advantage may include pilot awareness monitoring, which may be of increased importance in the event the aircraft 100 is operated by a single pilot wherein an alertness of the pilot needs to be maintained. The camera 146 may be used to monitor the head movements of the pilot to determine whether the pilot is drowsy. The controller 152 may determine the head movements of the pilot based on comparing images or frames of the video of the pilot. One of the processors may be capable of running an algorithm for determining from the images or video whether the pilot is drowsy or incapacitated in some way. If it is determined that the pilot's head movements indicate he is drowsy then the controller 152 may be used to generate warnings and attention getting devices to attract the attention of the pilot. It is also contemplated that the controller 152 may engage fully automatic operation of the aircraft and/or alert the ground that the pilot is incapacitated in some manner.

It is also contemplated that because the movement of the pilot may be determined from the images or video that gesture control may be used to control the HDD 142. More specifically, the controller 152 may determine the movements of the pilot as described above and the may operate the HDD 142 based on the determined movement of the pilot. This may result in a high interactive control approach.

The camera 146 may also be used for other functions such as video conferencing where compressed videos of the pilot may be sent to a ground receiver either via satellite, cellular phone, Wi-Fi connection, or some other connection. Alternatively, the video may be used for internal communications between the pilot and the flight attendants. Another advantage that may be realized is the recording of the repeatedly taken images or video and the storing of same in the memory 158. Such recordings may be examined later and may provide useful information about activities in the cockpit which would otherwise not be available.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A cockpit for an aircraft comprising:
a windscreen having at least one transparent pane through which light may pass;
at least one seat spaced from and facing the windscreen;
a flight deck having at least a portion disposed below the windscreen and having at least one head down display having an adjustable brightness that may be set by a brightness signal;
a camera having a field of view including at least a portion of the at least one seat and outputting an image signal indicative of luminance information within the field of view; and
a processor operably coupled to the camera and the head down display and configured to receive the image signal, determine a luminance of at least a portion of the field of view, determine a brightness for the head down display based on the determined luminance, and outputting to the head down display a brightness signal corresponding to the determined brightness.

2. The cockpit of claim 1 wherein the head down display has a viewing angle that overlaps at least a portion of the camera field of view.

3. The cockpit of claim 2 wherein the camera field of view encompasses the head down display viewing angle.

4. The cockpit of claim 2 or 3 wherein the overlapping portion includes at least a portion of the seat.

5. The cockpit of any of the preceding claims, further comprising a luminance target having a predetermined reflectance, with the luminance target located within the camera field of view.

6. The cockpit of any of the preceding claims, further comprising two seats in a side-by-side arrangement and where the camera field of view includes at least a portion of each of the two seats.

7. The cockpit of any of the preceding claims wherein the camera is mounted to the head down display.

8. The cockpit of claim 7 wherein the head down display is located below the windscreen.

9. The cockpit of any of the preceding claims wherein the processor comprises:
an image processor operably coupled to the camera to receive the image signal and output a luminance signal corresponding to the image signal; and
a graphics processor operably coupled to the image processor and receiving the luminance signal and correspondingly adjusting a brightness of the head down display.

10. The cockpit of any of the preceding claims wherein the camera is a video camera.

11. The cockpit substantially as hereinbefore described with reference to the accompanying drawings.
